(19) United States
(12) Patent Application Publication
(10) Pub. No.: US 2008/0107300 A1
(43) Pub. Date: May 8, 2008

(54) Headset Acoustic Device and Sound Channel Reproducing Method

(76) Inventor: Xiping Chen, Sichuan (CN)

Correspondence Address: Chan, Raymond Y., 108 N. Ynez Avenue, Suite 128, Monterey Park, CA, 91754, US

(21) Appl. No.: 11/791,558

(22) PCT Filed: Nov. 29, 2005
(86) PCT No.: PCT/CN05/02052

§ 371 Date: May 23, 2007

(30) Foreign Application Priority Data
Nov. 30, 2004 (CN) 200410081365.8

(51) Int. Cl. H04R 25/00

(52) U.S. Cl. 381/380

(57) ABSTRACT

A head acoustic device and a sound channel reproducing method discloses a multichannel acoustic device, especially a headset-multichannel acoustic device applying bone conduction speaker and a sound channel reproducing method. The headset-multichannel acoustic device of this invention includes a supporting frame and a vibration device on the frame, in which, the vibration device is a bone conduction speaker. The advantage of the present invention is that the sense of personally on the scene can be got by using the multichannel surround acoustic technology or by using the bone conduction speakers on different positions of bone and multichannel acoustic technology. On the other hand, it enables people with hearing handicap recover the ability of hearing music.

### BACKGROUND OF THE PRESENT INVENTION

1. Field of Invention

The present invention represents a multi-channel acoustic device, and more particularly to a multi-channel acoustic headset with bone conduction speakers and a sound channel reproducing method.

2. Description of Related Arts

Today, multichannel acoustic technology utilized in the stereo system can vividly reproduce the sound in nature and when applying this technology to an ordinary home theater system, the same acoustic effect can be achieved. Moreover, the same acoustic effect can also be achieved by properly arranging amplifiers in 5.1 channel system, including three channels for speakers at front (left, center and right), two channels for surround speakers at rear (left and right), and one low-frequency channel (subwoofer). Although listeners are more satisfactory with the 5.1 channel system, it can be used only in some specific circumstances because it interferes with people surrounding the listener.

With regard to headsets, some headset manufactures adopted virtual 5.1 channel technology by placing several independent sound-generating units in different parts of the headset to simulate the surrounding acoustic effect of 5.1 channel system. The advantages of these products are easy to manufacture and convenient to carry. However, this virtual 5.1 channel technology can be carried out only by combination of the sound-generating units with different frequencies and placing these units in different locations in the headset. Due to the size of the headset and limited means of wearing, the headset with virtual 5.1 channel can hardly reach the same acoustic effect as the home theater. Also, if the user wears the headset for a long time, he or she may feel uncomfortable because of dizzy or hurt of the ears.

In addition, the bone conduction speaker has several applications, such as hearing aids, earphones and cell phones. Through bone conduction, it can transform the sound to a kind of vibration to the ear bones, and thus achieve the goal to obtain sounds. Due to the limitation of structure, volume and consuming power, the application of the bone conduction speaker is limited to obtaining ordinary sound.

### SUMMARY OF THE PRESENT INVENTION

A main object of present invention is to provide a headset acoustic device to overcome the deficiencies in existing earphones and achieve good sound effect of surround or stereo acoustic system. Moreover, for those whose ear drum was impaired but with intact ear bone, this device can help them regain the ability to enjoy music. In other words, the headset acoustic device is considered as a hearing aid to help hard-of-hearing people hear music better.

Another object of the present invention is to provide a headset acoustic device with a sound channel reproducing method for achieving good acoustic effect of surround or stereo through bone conduction.

To solve existing technical problems stated above, the invention provides a headset acoustic device, comprising a supporting frame and a vibration device mounted on the frame, in which the vibration device comprises a bone conduction speaker.

The shape of the supporting frame matches the shape of human head, which enables the bone conduction speaker located on the supporting frame to have good contact of the head. There are at least two bone conduction speakers mounted on the supporting frame, locating on the left and right sides of the head of the user. The bone conduction speakers can also be placed on the left, right and rear sides of the head, whereas some bone conduction speakers can be place on the left, right, rear and top of the head. A pair of ordinary speakers is further located on the left and right sides of the head of the user. Preferably, the supporting frame has at least two bone conduction speakers, locating on the left and right sides of the head. The bone conduction speakers can also be placed on the left and right side of the head close to the ears, and the rear of the head. The bone conduction speakers on the supporting frame can also be located on the fore, left, right, top and rear of the head. At least a pair of ordinary speakers is placed close to the ears. The connection between the supporting frame and bone conduction speakers is soft and spongy connection.

The purpose of matching the shape of the supporting frame with human head is to enable the bone conduction speakers on the supporting frame to have good contact with the head. No specific requirement is needed regarding the appearance of the supporting frame to accomplish the goal of this invention. The present invention requires proper spatial arrangement of the bone conduction speakers under working condition to match the shape of human head. Obviously, “the shape of the supporting frame” should not be mechanically apprehended to its appearance.

The present invention further provides a sound channel reproducing method which distributes the bone conduction speakers on the surface of the head according to the direction of the origin of the sound.

The bone conduction speakers are placed according to one or more arrangements as following: on the fore head, symmetrically on the front of the ears close to temple, symmetrically on the left, right and rear of the head, on the lower jaw close to cheek, on the rear of the head, on the center of the top of the head or symmetrically on the left and right of the top of the head. A pair of ordinary speakers is place on the left and right sides of the head.

The best acoustic effect results from symmetric placement on the left and right sides of the head among the placements stated above.

The present invention fully takes advantage of the distinguishing feature of bone conduction speakers, which is transmitting sound through the medium of bone. People can tell the sound's direction and location by the ears when the sound is transmitted by air. Thus, utilizing multichannel surround acoustic technology enables people to have the same feeling as if they were in the realistic situation where the sound comes from. Similarly, using the same technology along with the bone conduction speakers placed on different locations of the head can also enable people to have the same feeling as stated above. Thus, this technology enables the portable acoustic device to achieve similar sound effect as in movie theaters. On the other hand, it enables people with hearing handicap regain the ability to enjoy music. Further description of the present invention is illustrated with the drawings and preferred embodiments.

### BRIEF DESCRIPTION OF THE DRAWINGS

FIG. 1A is a schematic view of a headset acoustic device according to a first preferred embodiment of the present invention, illustrating the position of the headset acoustic device with respect to the head of the user.

FIG. 1B is a schematic view of the headset acoustic device according to the above first preferred embodiment of the present invention.

FIG. 2A is a schematic view of a headset acoustic device according to a second preferred embodiment of the present invention, illustrating the position of the headset acoustic device with respect to the head of the user.

FIG. 2B is a schematic view of the headset acoustic device according to the above second preferred embodiment of the present invention.

FIG. 3A is a schematic view of a headset acoustic device according to a second preferred embodiment of the present invention, illustrating the position of the headset acoustic device with respect to the head of the user.

FIG. 3B is a schematic view of the headset acoustic device according to the above third preferred embodiment of the present invention.

### DETAILED DESCRIPTION OF PREFERRED EMBODIMENT

In the embodiments, the sound is originated from widely used 5.1 channel surround stereo acoustic system, and other multichannel stereo acoustic systems can be adopted by similar means in the embodiments in the present invention. The “ordinary speaker” in the present invention means the sound of the speaker is transmitted through air.

### Embodiment 1

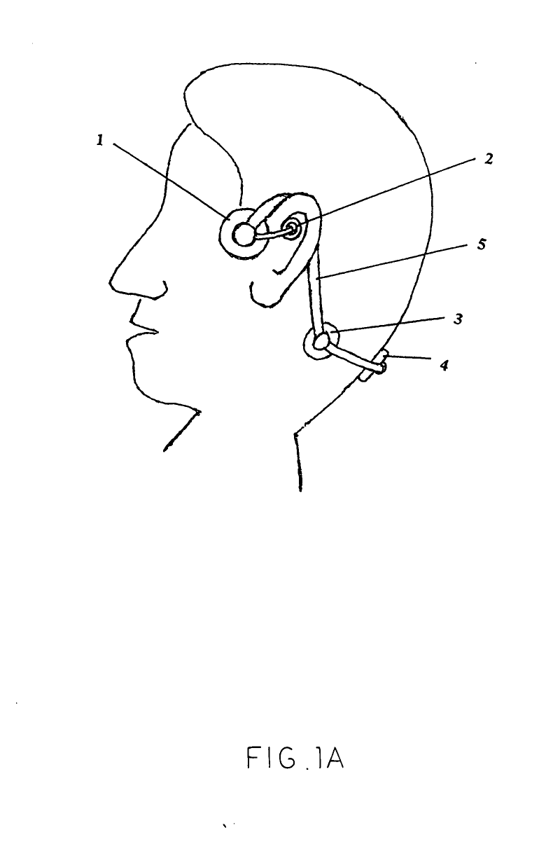

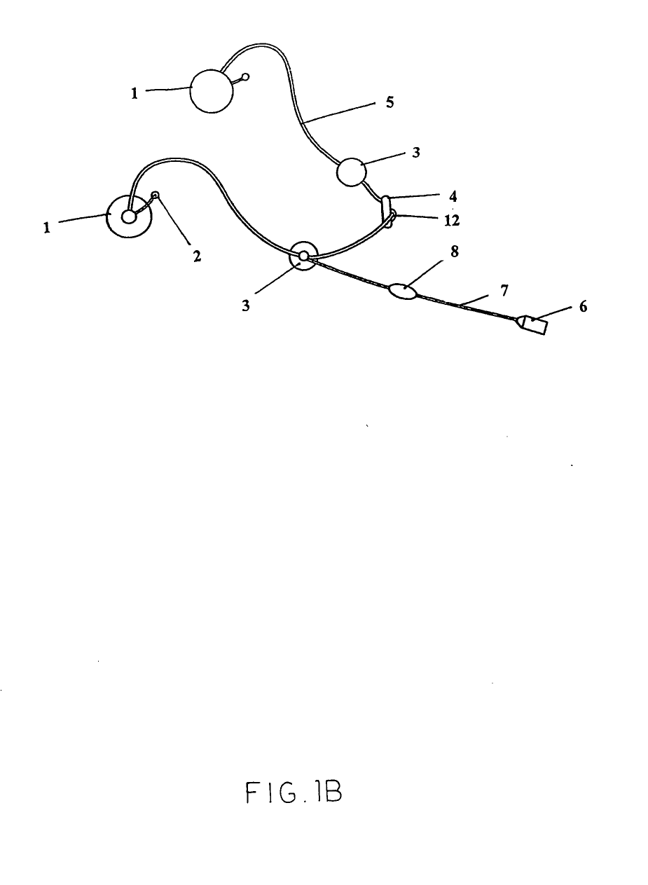

Users can wear the headset acoustic device of the present invention as illustrated in FIG. 1A. The speakers “locating on the left and right sides of the head” means that after the acoustic device is worn by the user, the bone conduction speakers on the device are located on the left and right sides of the head of the user.

As illustrated in FIG. 1B, the device hangs on the ears with five bone conduction speakers which are connected by supporting frame 5 made by hollow tubes in this embodiment. Supporting frame 5 has certain extent of flexibility which enables each speaker to be appropriately placed on the head. In other words, the supporting frame 5 can be adjustably bent to fit the shape of the head of the user such that the supporting frame 5 can be worn by means of resilient force to ensure the bone conduction speakers contacting with the head of the user. Users can choose their own sizes among several different sizes of the device. Each bone conduction speaker is placed on supporting frame 5 through an interference-free connector 12 which is made by soft materials and utilized to prevent interference resulting from the vibration from other bone conduction speakers. S terminal connector 6 is used to connect to the output terminal of 5.1 channel surround stereo acoustic system. One end of the cable of each channel in connecting cable 7 is connected to the corresponding site at the S terminal connector 6, whereas the other end is connected to the corresponding bone conduction speaker through the hollow tube of supporting frame 5. Connecting cable 7 also incorporates with a volume adjustment device 8 which can adjust the volume of the bone conduction speakers respectively. Connecting cable 7 can select any bone conduction speaker to be its cable inlet.

In this embodiment, the function of each bone conduction speaker is: two bone conduction speakers 1 are connected to the left and right front channels for locating at two temples of the user respectively; two bone conduction speakers 2 are connected to the central channel for locating at two ears of the user respectively; two bone conduction speakers 3 are connected to the left and right surround channels for locating at two rear-sides of the user respectively; and one bone conduction speaker 4 is connected to the low-frequency channel for locating at the back of the head of the user.

### Embodiment 2

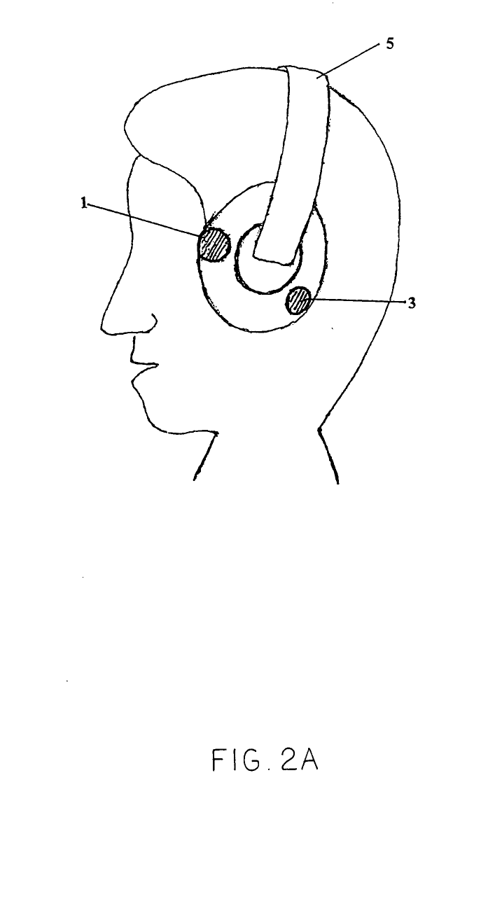

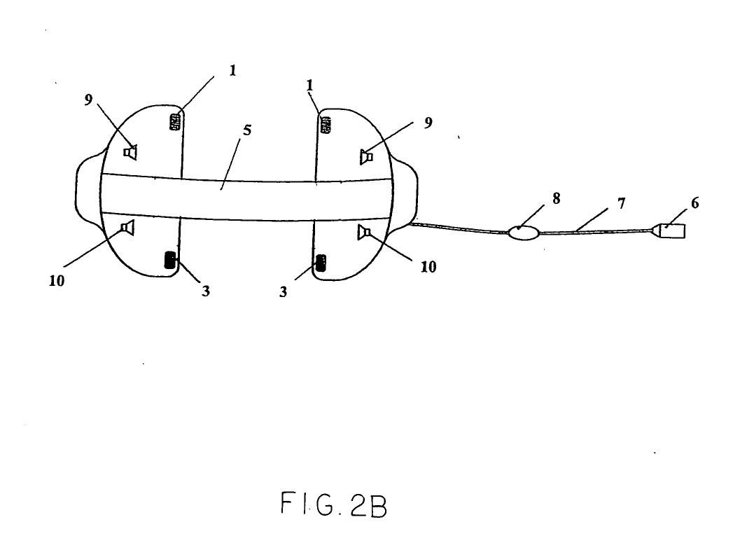

Users can wear the headset with multichannel surround stereo acoustic device as illustrated in FIG. 2A.

As illustrated in FIG. 2A, the headset device in this embodiment comprises four bone conduction speakers and four air conduction speakers, wherein two earphones incorporated with two ear covers are preferred to be used for locating at the ears of the user respectively. Users' ears are under less stress by using the hollow ear covers wherein four bone conduction speakers are placed on proper locations of the head. Four air conduction speakers are placed at the outer portion of ear covers respectively. The headset according to the second embodiment comprises a supporting frame 5 which connects two earphones on the left and right sides. The supporting frame 5 has certain flexibility which enables each bone conduction speaker to place on the appropriate position on the head. S terminal connector 6 is used to connect to the output terminal of 5.1 channel surround stereo acoustic system. Connecting cable 7 can select one earphone to be its cable inlet, and the cable of the other earphone goes inside through supporting frame 5. The cable of each channel in connecting cable 7 has one end connected to the corresponding site at the S connector, and the other end is connected to the speaker of each channel. Connecting cable 7 also incorporates with a volume adjustment device 8 which can adjust the volume of the speakers respectively.

In this embodiment, the function of each speaker is: two bone conduction speakers 1 are connected to the left and right front channels and are located at two inner-front portions of the earphones respectively; two bone conduction speakers 3 are connected to the left and right surround channels and are located at two inner-rear portions of the earphones respectively; two air conduction speakers 9 are connected to the central channel and are located at two outer-front portions of the earphones respectively; and two air conduction speakers 10 are connected to the low-frequency channel and are located at two outer-rear portions of the earphones.

### Embodiment 3

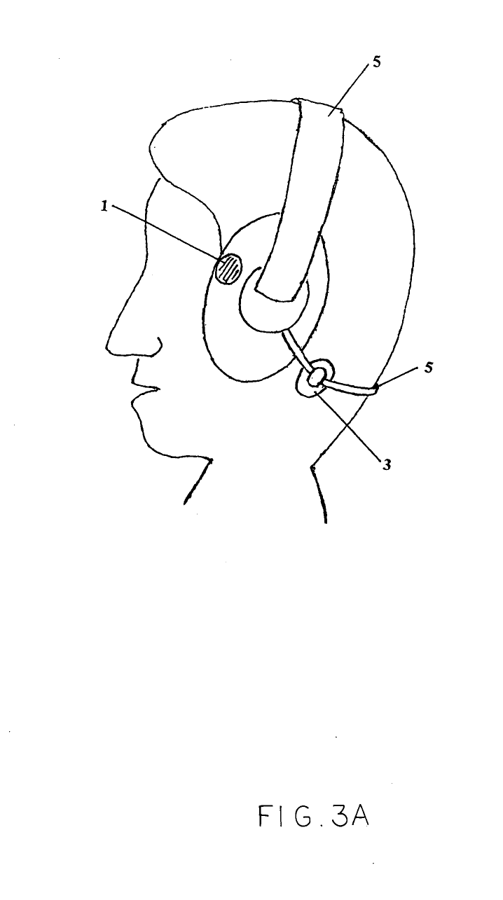

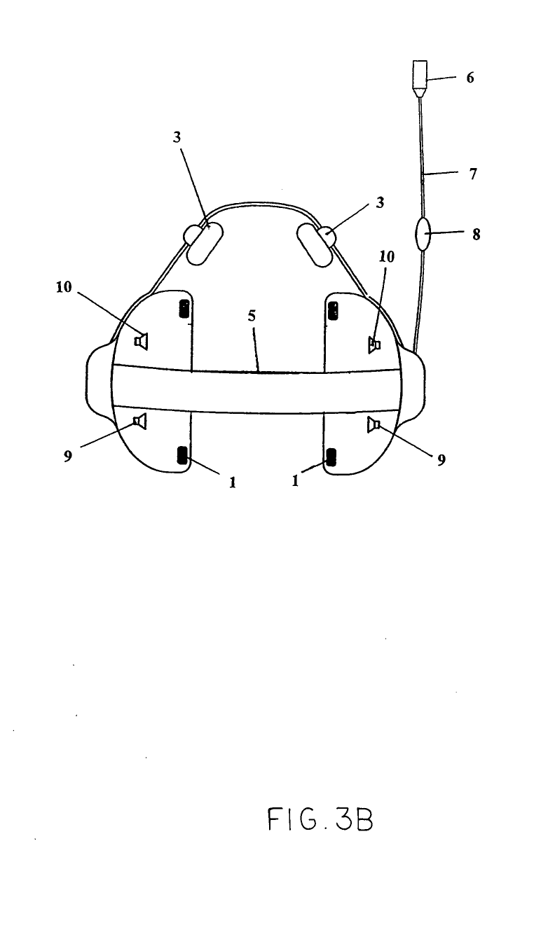

Users can wear the headset with multichannel surround stereo acoustic device as illustrated in FIG. 3A.

As illustrated in FIG. 3B, the headset device in this embodiment comprises four bone conduction speaker and four air conduction speakers, wherein two earphones incorporated with two ear covers are preferred to be used for locating at the ears of the user respectively. Users' ears are under less stress by using the hollow ear covers wherein two bone conduction speakers are placed on proper locations of the head. The other two bone conduction speakers are fixed on supporting frame 5 through soft connector 12. Four air conduction speakers are placed on the rear end of the ear covers. The headset in this embodiment comprises a supporting frame 5 which connects two earphones on the left and right sides while another supporting frame 5 which connects the two bone conduction speakers 3 to the earphones. The supporting frame has certain flexibility which enables each bone conduction speaker to be placed on appropriate position on the head. S connector 6 is used to connect to the output terminal of 5.1 channel surround stereo acoustic system. Connecting cable 7 can select one earphone to be its cable inlet, and the inlet cable of the other earphone goes inside through supporting frame 5. The cable of each channel in connecting cable 7 has one end connected to the corresponding site at the S terminal connector 6, and the other end is connected to the speaker of each channel. Connecting cable 7 also incorporates with a volume adjustment device 8 which can adjust the volume of the speakers respectively.

In this embodiment, the function of each speaker is: two bone conduction speakers 1 are connected to the left and right front channels and are located at two inner-front sides of the earphone respectively; two bone conduction speakers 3 are connected to the left and right surround channels for locating at two rear sides of the user respectively; two air conduction speakers 9 are connected to the central channel and are located at two outer-front sides of the earphone respectively; and two air conduction speakers 10 are connected to the low-frequency channel and are located at two outer-rear sides of the earphone respectively.

What is claimed is:

1. A headset acoustic device, comprising a supporting frame and a vibration apparatus placed on said supporting frame, wherein said vibration apparatus comprises one or more bone conduction speakers.

2. The headset acoustic device, as recited in claim 1, wherein the shape of said supporting frame is shaped for matching the shape of head of a user, such that the bone conduction speaker mounted on said supporting frame is adapted for substantially contacting with the head of the user.

3. The headset acoustic device, as recited in claim 2, wherein at least two said bone conduction speakers are spacedly mounted at said supporting for locating on the left and right sides of the head of the user.

4. The headset acoustic device, as recited in claim 2, wherein said bone conduction speakers are symmetrically located on the left and right sides of the head close to the ears, and on the rear of the head.

5. The headset acoustic device, as recited in claim 2, wherein the bone conduction speakers are located on the left and right sides of the head, and the top and rear of the head.

6. The headset acoustic device, as recited in any of the preceding claims, wherein at least a pair of air conduction speakers is mounted on said supporting frame for locating on the left and right sides of the head close to the ears.

7. The headset acoustic device, as in claim 1, 2, 3, 4 or 5, wherein the supporting frame and the bone conduction speaker are connected via an interference-free connector.

8. A sound channel reproducing method, comprising the step of locating a plurality of bone conduction speakers on the surface of the head of a user, according to the direction of the origin of the sound.

9. The method, as recited in claim 8, wherein the bone conduction speakers are placed by one of the following configuration: on the fore head, symmetrically on both sides of the front ears, symmetrically on both sides of the rear head, on the lower cheek, on the rear of the head, and on the center of the top of the head or symmetrically on both sides of the top of the head.

10. The method, as recited in claim 9, wherein at the least one said pair of air conduction speakers is located on the left and right sides of the head.
